(19) United States
(12) Patent Application Publication
(10) Pub. No.: US 2010/0105384 A1
(43) Pub. Date: Apr. 29, 2010

(54) LOCATION ROUTING AREA UPDATE PROCEDURES FOR MOBILE COMMUNICATION SYSTEMS

(76) Inventor: Ajay Vachhani, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/450,734

(22) PCT Filed: Mar. 27, 2008
(86) PCT No.: PCT/JP2008/056650

§ 371 Date: Oct. 9, 2009

(30) Foreign Application Priority Data
Apr. 13, 2007 (GB) 0707181.4

(51) Int. Cl. H04W 60/00

(52) U.S. Cl. 455/435.1

(57) ABSTRACT

A method for instigating a location/routing area update procedure (LAU/RAU) when a piece of user equipment (UE) reselects its communication base station from a macro base station to a shorter range base station positioned within a macro cell of the macro base station is disclosed. The method comprises the steps of establishing a radio resource control connection between the UE and the shorter range base station; registering the UE with the shorter range base station; assigning location area code data (LAC) and routing area code data (RAC) from the shorter range base station to the UE; wherein the LAC and RAC data are the same data as the LAC and RAC data provided to the UE by the macro cell base station, whereby the UE does not perform a LAU/RAU procedure when it moves out of range of the shorter range base station and recommences communication with the macro base station.

### FIELD OF THE INVENTION

This invention relates to location routing area update procedures (LAU/RAU) for mobile communication systems and in particular to procedures used when user equipment (UE) moves between different types of macro cell and access points.

### BACKGROUND TO THE INVENTION

Mobile communication systems operate on a cellular basis in which transmission and receiver base stations coupled to a network provide transmission and reception to UE such as mobile telephones in each cell in the network. Several cells together form a location/routing area. The location area always contains more cells than the routing area. When user equipment such as mobile telephones move between areas, there is a location/routing area update procedure (if the new cell is in a different Location/Routing area) in which the user equipment selects a new area for receiving and transmitting to and ends transmitting and receiving in the other area. The base stations and cells may be referred to as macro base stations and macro cells.

Smaller cell sites called pico sites have been proposed. These cover a smaller area such as a complex of buildings. Still smaller cell sites named Femto cells are also proposed. This is a term used by mobile operations to refer to smaller cell sites of a type which attempt to solve the often expensive problem of providing complete in-building coverage. Pico cells can have problems with local multipath distortion etc in providing coverage to the complete building.

A Femto cell which is often referred to as an access point/home gateway is a small plug and play device which communicates with user equipment such as mobile handsets using standard 2G or 3G transmission and reception. It is connected to a network via a Broadband service using either xDSL (Digital Subscriber Loop) or WIMAX technology. Optionally the Femto cell can incorporate the functionality of a Broadband router so that a user has a complete integrated device. It is essential that it integrates seamlessly with the core network (CN) of the mobile communication system so that it can be remotely managed and updated.

In mobile communication networks operated on macro cells, the base station in each cell has a unique location area code (LAC and a routing area code (RAC)). A location/routing area update procedure (LAU/RAU) is performed every time the user equipment moves between macro cells with different LAC data, that is to say if the new cell is in a different Location/Routing area than the old cell used by the UE.

When Femto cells are used, there may be thousands of Femto cells deployed in a single macro cell. Instigating a LAU/RAU procedure every time when a piece of user equipment starts or stops communicating with a Femto cell will lead to a significant amount of additional transmission and reception with the macro base station and a significant amount of network signalling. If there are many Femto cells in each macro cell then this could lead to overloading of a network, particularly at busy times.

### SUMMARY OF THE INVENTION

Preferred embodiments of the present invention seek to avoid the need to perform the LAU/RAU procedure on all occasions thereby reducing the amount of air and network signalling in a mobile communication system.

In accordance with one embodiment of the invention there is provided a method for instigating a location/routing area update procedure when a piece of user equipment moves from communication with a macro cell to communication with a shorter range cell. It does this by broadcasting different location area code (LAC)/routing area code (RAC) data to that of the macro cell in which the Femto cell is positioned to the user equipment and uses this to instigate connection of the user equipment to the shorter range cell. Subsequently it assigns the LAC/RAC of the macro cell in which the Femto cell is positioned to the user equipment, whereby the user equipment does not perform the LAU/RAU procedure as it moves from communication with the shorter range cell to communication with the macro cell.

This and further aspects of the invention are defined in the appended claims to which reference should now be made.

### BRIEF DESCRIPTION OF THE DRAWINGS

A preferred embodiment of the invention will now be described in detail by way of example with reference to the accompanying drawings in which:

FIG. 1 shows a schematic diagram of a Femto cell connected to a network and in communication with user equipment:

FIG. 2 shows a schematic diagram a macro cell with a base station and a number of Femto cells present within it; and

FIG. 3 shows a message sequence chart for registration of a piece of user equipment with a Femto cell.

FIG. 4 shows a block schematic diagram of an access point in a Femto cell.

### EXEMPLARY EMBODIMENTS

In FIG. 1 there is shown a Femto cell 2 which is coupled to a network at 4. This will be a hard wired connection. The Femto cell comprises a Femto cell gateway 6 and an access point 8 coupled by a Broadband connection 10. The access point has coupled to it a transmitter/receiver 12 which transmits and receives signals over a short distance to user equipment positioned within range. The user equipment may be for example, a mobile phone 14 or a data card 16 attached to a laptop 18. User equipment which comes within range of a Femto cell access point may communicate directly with that access point if it is authorised to do so, and does this in preference to communication with a macro cell within which it is positioned.

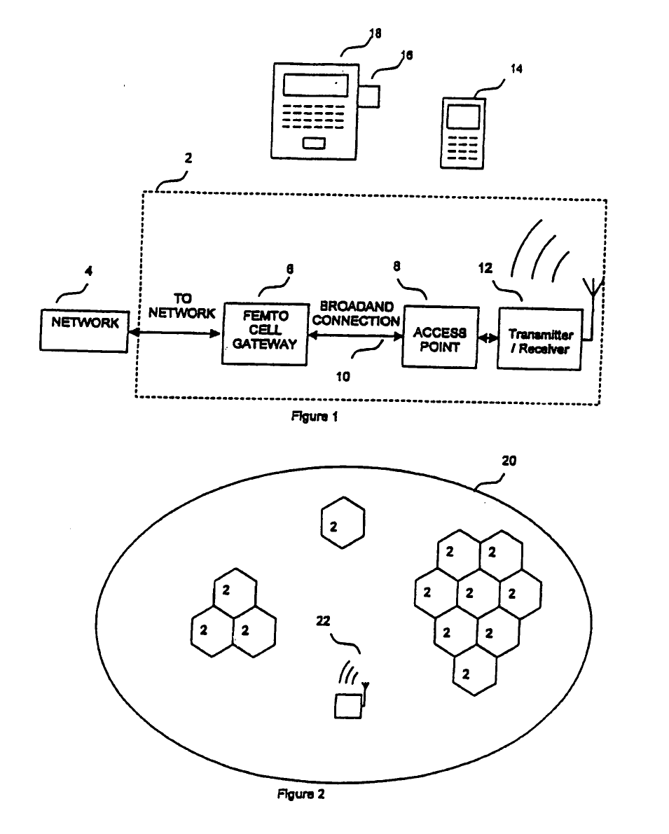

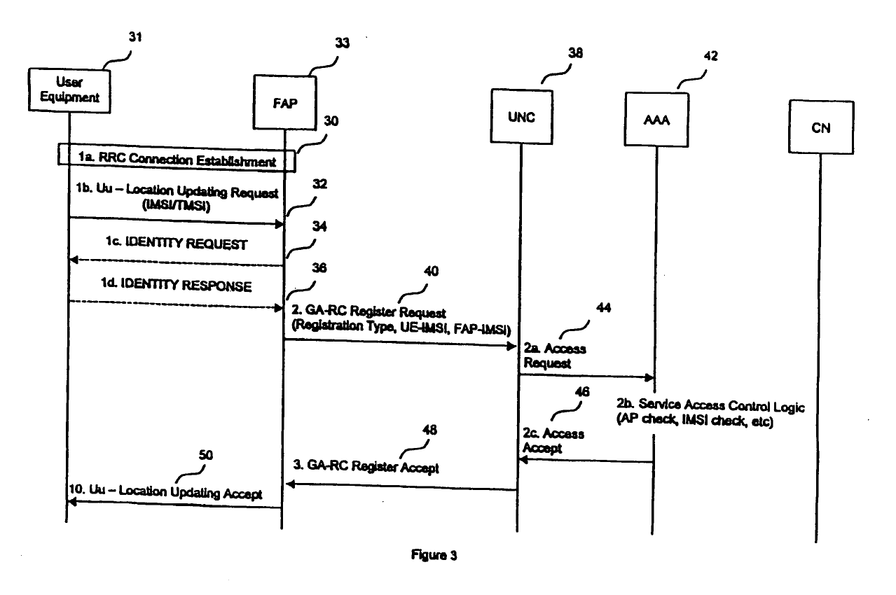

In FIG. 2, a schematic diagram of a macro cell 20 is shown. This has a base station 22 which transmits and receives signals from user equipment positioned within it. Further positioned within the macro cell are a plurality of Femto cells 2. These may comprise clusters of Femto cells 2 as may be required in a large office building or individual cells which may be used in private homes for example. In practice, in a city many thousands of Femto cells could be present within a single macro cell.

When a piece of user equipment such as a handset 14 or data card 16 registers with a macro cell, it goes through a registration LAU/RAU procedure in which the macro cell transmits its RAC/LAC data to the user equipment and the user equipment stores this. This data is not subsequently used during transmissions between the user equipment and the macro cell. It is there for comparison purposes when the user equipment tries to register with a different macro cell.

FIG. 3 shows a message sequence chart showing the registration procedure when a piece of user equipment (UE) registers with a Femto cell access point (FAP). The first step is that a radio resource control connection is established at 30. This is performed by the FAP when it recognises that a piece of UE is within range of it. This is followed by a location updating request from the UE to the FAP at 32. In response to this the FAP sends an identity request to the UE at 34 and the UE sends its identity response back to the FAP at 36. The FAP now has an identity of the UE which wishes to register with it. A generic access register request is then sent to a UMA network controller (UNC3) 38 at 40. This passes the access request to an access authorisation and accounting module (AAA) 42 at 44. If the UE 31 is authorised to communicate with the FAP 33 then an access accept message is sent from the AAA at 46 to the UNC and onto the FAP at 48. Subsequently appropriate LAC/RAC data is sent to the UE at 50.

When the RRC connection is established at 30, the UE 31 recognises the FAP 33 having a different system information LAC/RAC data to the macro cell with which it is currently in communication. This initialises the procedure summarised above. However, when the LAC/RAC data is sent to the UE 31 at step 50, the actual LAC/RAC data sent is the same as that of the macro cell, i.e. it is the same of that currently stored in the UE. Thus, the UE 31 has been registered with the FAP but with the same LAC/RAC data as the macro cell. As the FAP shares the same LAC/RAC data as the macro cell the network controller sends messages for the UE to the FAP 33 for transmission to the UE 31 and messages transmitted by UE 31 will be received by FAP and sent to the network. The network does not require any signalling to it that the UE is now communicating with the FAP and thus network signalling does not increase. However, the actual location data stored in the UE is the same as was stored when in communication with the macro cell. Thus it continues to transmit and receive messages as before.

The UE does not make any regular checks on the LAC/RAC data unless it receives a signal from the access point that system information is being changed. The system information comprises a number of different pieces of data including the LAC/RAC data. Thus, once the UE has registered with an FAP, it will not try to repeatedly reregister itself since the system information will remain constant unless there is some other reason for changing the system information from the FAP.

When the UE moves away from the FAP 33 it will go out of range of the FAP and the RRC connection will be broken. Messages transmitted by the network for the UE 31 will then subsequently be received from the macro cell 20 within which the FAP 33 is located, until such time as the UE 31 registers with another or the same FAP or moves to another macro cell.

Thus, it will be appreciated that every time a UE comes within range of an FAP 33 it performs the LAU/RAU procedure to register with that FAP 33. However, the LAC/RAC data sent to the UE 31 will be the same as that of the macro cell within which the FAP is positioned. Therefore, when the UE moves out of range of the FAP but stays within the current macro cell there is no requirement for the LAU/RAU procedure to be performed again.

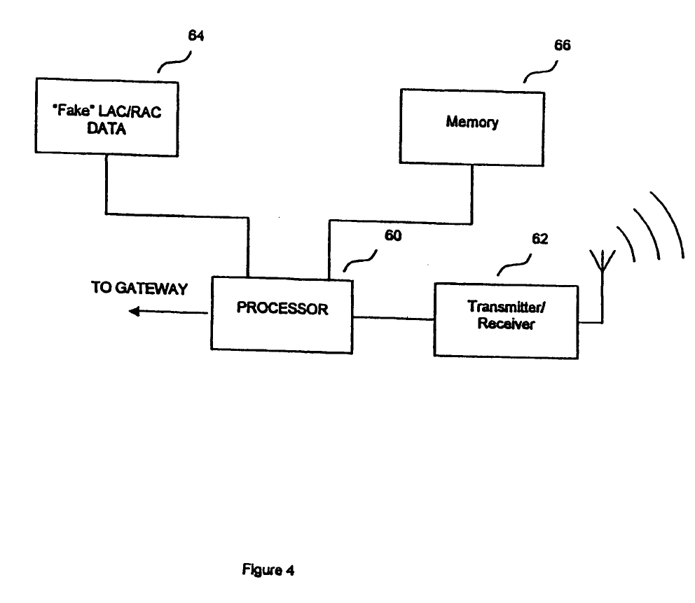

FIG. 4 shows schematically circuits within the FAP. This comprises a processor 60 to control messaging to the network and to an associated transmitter/receiver 62. A memory 64 stores “fake” LAC/RAC data which is used to initiate a LAU/RAU procedure. A second memory 66 stores LAC/RAC data corresponding to that of the macro cell in which the FAP is positioned. This is the LAC/RAC data which is actually sent to a piece of UE which registers with the FAP, and which removes the need for the UE to re-register with the macro cell when it moves out of range of the FAP. The memories 64 and 66 may be provided separately or in a single memory.

This application is based upon and claims the benefit of priority from GB patent application No. 0707181.4, filed on Apr. 13, 2007, the disclosure of which is incorporated herein in its entirety by reference.

1. A method for instigating a location/routing area update procedure (LAU/RAU) when a piece of user equipment (UE) reselects its communication base station from a macro base station to a shorter range base station positioned within a macro cell of the macro base station, said method comprising:
establishing a radio resource control connection between the UE and the shorter range base station;
registering the UE with the shorter range base station; and
assigning location area code data (LAC) and routing area code data (RAC) from the shorter range base station to the UE,
wherein the LAC and RAC data are the same data as the LAC and RAC data provided to the UE by the macro cell base station, whereby the UE does not perform a LAU/RAU procedure when it moves out of range of the shorter range base station and recommences communication with the macro base station.

2. A method according to claim 1, wherein the shorter range base station shares the LAC/RAC data of the macro cell whereby no network signalling is required when the UE moves between the shorter range base station and the macro cell.

3. A method according to claim 1, further including determining whether the UE is authorized to communicate with the shorter range base station.

4. A system for instigating a location/routing area update procedure (LAU/RAU) when a piece of user equipment (UE) reselects its communication base station from a macro base station to a shorter range base station positioned within a macro cell of the macro base station, said system comprising:
a unit that establishes a radio resource control connection between the UE and the shorter range base station;
a unit that registers the UE with the shorter range base station; and
a unit that assigns location area code data (LAC) and routing area code data (RAC) from the shorter range base station to the UE,
wherein the LAC and RAC data are the same data as the LAC and RAC data provided to the UE by the macro cell base station, whereby the UE does not perform a LAU/RAU procedure when it moves out of range of the shorter range base station and recommences communication with the macro base station.

5. A system according to claim 4, wherein the shorter range base station shares the LAC/RAC data of the macro cell whereby no network signalling is required when the UE moves between the shorter range base station and the macro cell.

6. A system according to claim 4, further including a unit that determines whether the UE is authorized to communicate with the shorter range base station.

7. A short range base station for use within a macro cell of a cellular communication system, said short range base station comprising:
a unit that instigates a LAU/RAU procedure upon establishment of a radio resource control connection with a piece of user equipment (UE);
a unit that stores LAC/RAC data different to that of the macro cell within which it is positioned the data being used to instigate the LAU/RAU procedure; and
a unit that assigns LAC/RAC data corresponding to LAC/RAC data of the macro cell on completion of a successful LAU/RAU procedure.

8. A method for performing an LAU/RAU procedure at a short range base station for use within a macro cell of a cellular communication system, said method comprising:
instigating the LAU/RAU procedure upon establishment of a radio resource control connection with a piece of user equipment (UE);
using LAC/RAC data different to that of the macro cell to instigate the LAU/RAU procedure; and
assigning LAC/RAC data corresponding to that of the macro cell within which the short range base station is positioned on completion of the LAU/RAU procedure.

9.-11. (canceled)

12. A system for instigating a location/routing area update procedure (LAU/RAU) when a piece of user equipment (UE) reselects its communication base station from a macro base station to a shorter range base station positioned within a macro cell of the macro base station, said system comprising:
means for establishing a radio resource control connectin between the UE and the shorter range base station; and
means for registering the UE with the shorter range base station;
means for assigning location area code data (LAC) and routing area code data (RAC) from the shorter range base station to the UE,
wherein the LAC and RAC data are the same data as the LAC and RAC data provided to the UE by the macro cell base station, whereby the UE does not perform a LAU/RAU procedure when it moves out of range of the shorter range base station and recommences communication with the macro base station.

13. A short range base station for use within a macro cell of a cellular communication system, said short range base station comprising:
means for instigating a LAU/RAU procedure upon establishment of a radio resource control connection with a piece of user equipment (UE);
means for storing LAC/RAC dada different to that of the macro cell within which it is positioned the data being used to instigate the LAU/RAU procedure; and
means for assigning LAC/RAC data corresponding to LAC/RAC data of the macro cell on completion of a successful LAU/RAU procedure.
